(19) United States
(12) Patent Application Publication
(10) Pub. No.: US 2012/0275396 A1
(43) Pub. Date: Nov. 1, 2012

(54) METHOD FOR SETTING UP A COMMUNICATION CONNECTION

(75) Inventor: Zheng Cai, Fairfax, VA (US)

(73) Assignee: NII HOLDINGS, INC., Reston, VA (US)

(21) Appl. No.: 13/381,545

(22) PCT Filed: Apr. 29, 2011
(86) PCT No.: PCT/US11/34647

§ 371 Date: Dec. 29, 2011

(51) Int. Cl. H04W 76/02; H04W 4/10; H04W 72/04

(52) U.S. Cl. 370/329

(57) ABSTRACT

A method of a first device setting up a communication connection is provided, comprising: sending a communications request to a system server over a control channel, requesting the communications connection between the first device and a second device; receiving a status message from the system server indicating that a dedicated traffic channel is being set up by the second device; determining whether the dedicated traffic channel has been properly set up for the first device; sending data packets over the dedicated traffic channel to the second device if it is determined that the dedicated traffic channel has been properly set up; and indicating an unsuccessful connection if it is determined that the dedicated traffic channel has not been properly set up.

### FIELD OF THE INVENTION

The present claimed invention relates in general to communication connection set-up in communication system. More specifically it relates to a system and method by which communications connections in communication system can be set-up more quickly by performing tasks in parallel at a source and a destination device through a control channel, and guaranteeing resource allocation. Such communication connection could be a push-to-talk (PTT) call, a connection in a gaming environment between two remote terminals, or any situation in which low latency is permitted, but a guaranteed connection is required.

### BACKGROUND OF THE INVENTION

In many data commutations connections today, a guaranteed connection is required, but low latency is permitted in the connection. The need for a guaranteed connection means that whatever coordinates the commutations connections (a designated server, an ad hoc network coordinator, one of the devices communicating, etc.) must guarantee that when two devices communicate, there will be some guaranteed amount of connection between them, whether it be a guaranteed connection duration, a guaranteed number of packets exchanged over a period of time, a guaranteed portion of a set bandwidth allocated to the devices, etc. The permissibility of low latency means that certain small delays are allowable in the transmission of data, the delays depending upon the particular implementation.

Both a push-to-talk (PTT) call and a voice over IP (VoIP) call require a guaranteed connection to ensure that the voice traffic will pass without interruption. However, each of these embodiments allows for any delay of transmission that will not be noticeable to the human ear. Similarly, an online gaming regime requires a guaranteed connection to ensure that game play is not interrupted, but may acknowledge that some connections will have low latency. Such gaming regimes can actually design their games to require a certain amount of low latency based on the latency suffered by its users so as to minimize the comparative disadvantages of increased latency on players.

A push-to-talk (PTT) is a communication regime in which two or more handsets (e.g., cell phones) can enter into half-duplex communication with each other, where only one party can transfer voice data at a time, rather than full duplex communication in which multiple parties can transmit voice data at the same time. In this way PTT operates similar to walkie-talkies in which one person must push a button to claim the air space to talk and then release it to allow the other party the option to push the corresponding button on their handset to pass their voice over the transmission medium.

PTT can be cheaper to operate since half-duplex communication is typically simpler to operate than full duplex, and less greedy of bandwidth. Also, PTT typically offers a quicker connection protocol, allowing for more instantaneous and casual conversations.

One important issue with PTT systems in the time required for setting up a connection between two devices. Users typically expect that when they push the talk button, they will be connected immediately, which is to say, in a time period that appears to a user to be almost instantaneous.

However, current PTT systems require a fair amount of time during a PTT connection in order to set up a desired traffic channel at both a calling handset and a called handset. In operation, the calling handset must first set up a traffic channel before it can make a call request to the called handset. The called handset must likewise set up a traffic channel before it can send an acknowledgement message to the calling handset to complete the PTT connection.

It would therefore be desirable to provide a quicker and more efficient system and method for setting up a communications connection in which it is not necessary to wait for each terminal to set up a traffic channel.

### SUMMARY OF THE INVENTION

A method of a first device setting up a communication connection is provide, comprising: sending a communications request to a system server over a control channel, requesting the communications connection between the first device and a second device; receiving a status message from the system server indicating that a dedicated traffic channel is being set up by the second device; determining whether the dedicated traffic channel has been properly set up for the first device; sending data packets over the dedicated traffic channel to the second device if it is determined that the dedicated traffic channel has been properly set up; and indicating an unsuccessful connection if it is determined that the dedicated traffic channel has not been properly set up.

The communications connection may be a push-to-talk (PTT) call, the system server may be a PTT server, the communication request may be a PTT request, and the data packets may be PTT packets. Alternately, the communications connection may be a game-playing connection, the system server may be a gaming server, the communication request may be a game request, and the data packets may be gaming packets Alternately, the communications connection may be a voice over IP (VoIP) call, the system server may be a VoIP server, the communication request may be a VoIP request, and the data packets may be VoIP packets.

The communications request may be sent to the system server via a local radio network, and the status message may be received from the system server via the local radio network. The local radio network may be a universal terrestrial radio access network (UTRAN).

The operation of indicating an unsuccessful connection may include one of sounding a tone on the first device, displaying a message on the first device, or playing a sound file on the first device. The operation of determining whether the dedicated traffic channel has been properly set up may include: determining whether the first device is in a dedicated channel state.

A method of a first device setting up a communications connection is provided, comprising: sending a communications request to a system server over a control channel, requesting the communications connection between the first device and the second device; listening for timeout period for a status message from the system server over the control channel, the status message indicating that a dedicated traffic channel is being set up by the second device; repeating the operations of sending the communications request and listening for timeout period for the status message a set number of times if the status message is not received from the system server within the timeout period; determining whether the dedicated traffic channel has been properly set up if the status message is received from the system server within the timeout period; sending data packets over the dedicated traffic channel to the second device if it is determined that the dedicated traffic channel has been properly set up; and indicating an unsuccessful connection if it is determined that the dedicated traffic channel has not been properly set up or if no status message is heard after repeating the operations of sending the communications request and listening for timeout period for the status message the set number of times.

The communications connection may be a push-to-talk (PTT) call, the system server may be a PTT server, the communication request may be a PTT request, and the data packets may be PTT packets. Alternately, the communications connection may be a game-playing connection, the system server may be a gaming server, the communication request may be a game request, and the data packets may be gaming packets.

The communications request may be sent to the system server via a local radio network; and the status message may be received from the system server via the local radio network. The local radio network may be a universal terrestrial radio access network (UTRAN).

The operation of indicating an unsuccessful connection may include one of sounding a tone on the source device, displaying a message on the source device, or playing a sound file on the source device. The operation of determining whether the dedicated traffic channel has been properly set up may include: determining whether the first device is in a dedicated channel state.

A method of a radio network controller setting up a communications connection is provided, comprising: receiving a communications request from a system server over a control channel, requesting the communications connection be set up between with a remote device; receiving a status message from the system server indicating that a dedicated traffic channel is being set up; determining whether the dedicated traffic channel has been properly set up; sending data packets over the dedicated traffic channel if it is determined that the dedicated traffic channel has been properly set up; repeating the operations of sending a communications request, receiving a status and indicating an unsuccessful connection if it is determined that the dedicated traffic channel has not been properly set up.

The communications connection may be a push-to-talk (PTT) call, the system server may be a PTT server, the communication request may be a PTT request, and the data packets may be PTT packets. Alternately, the communications connection may be a game-playing connection, the system server may be a gaming server, the communication request may be a game request, and the data packets may be gaming packets.

A method of a controller setting up a communications connection is provided, comprising: receiving a connection announcement from a system server over a control channel, the connection announcement requesting a communications connection between a first device and a second device; determining whether required resources are available at the second device to handle the communications; discarding the connection announcement if it is determined that the required resources are not available at the second device to handle the communications; reserving the required resources at the second device if it is determined that the required resources are available at the second device to handle the communications; sending the connection announcement to the second device if it is determined that the required resources are available at the second device to handle the communications; receiving a connection announcement acknowledgement from the second device if the connection announcement was sent to the second device; and sending the connection announcement acknowledgement to the system server if the connection announcement acknowledgement was received from the second device.

The communications connection may be a push-to-talk (PTT) call, the connection announcement may be a push-to-talk (PTT) call announcement, and the system server may be a PTT server. Alternately, the communications connection may be a game-playing connection, the connection announcement may be a game connection announcement, and the system server may be a gaming server.

The second controller may be a part of a local radio network that is connected between the second device and the system server. The local radio network may be a universal terrestrial radio access network (UTRAN).

The method may further comprise: performing a packet inspection on the connection announcement prior to determining whether sufficient resources are available at the second device to handle the communications. The method may further comprise: sending a negative acknowledgement packet to the first device via the system server, indicating negative acknowledgement of the call request, after discarding the connection announcement if it is determined that sufficient resources are not available at the second device to handle the communications.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram of a communication network according to disclosed embodiments;

FIG. 2 is a system flow diagram showing call setup according to a disclosed embodiment;

FIG. 3 is a flow chart showing call setup between two devices according to disclosed embodiments;

FIG. 4 is a flow chart showing the retransmission of a call request according to disclosed embodiments; and

FIG. 5 is a flow chart showing call setup at a destination controller according to disclosed embodiments.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs). It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

The following disclosure is made, by way of example, using a push-to-talk (PTT) communication network. However, the methods disclosed below could be equally applied to other communications regimes that require a guaranteed connection, but allow for some amount of low latency. Such regimes include, but are not limited to, internet gaming regimes and voice over IP (VoIP) regimes. Alternate embodiments could regulate the connection of a VoIP call or an internet gaming connection in a manner analogous to that shown below with respect to the connection of a PTT call.

Push-to-Talk Communication System

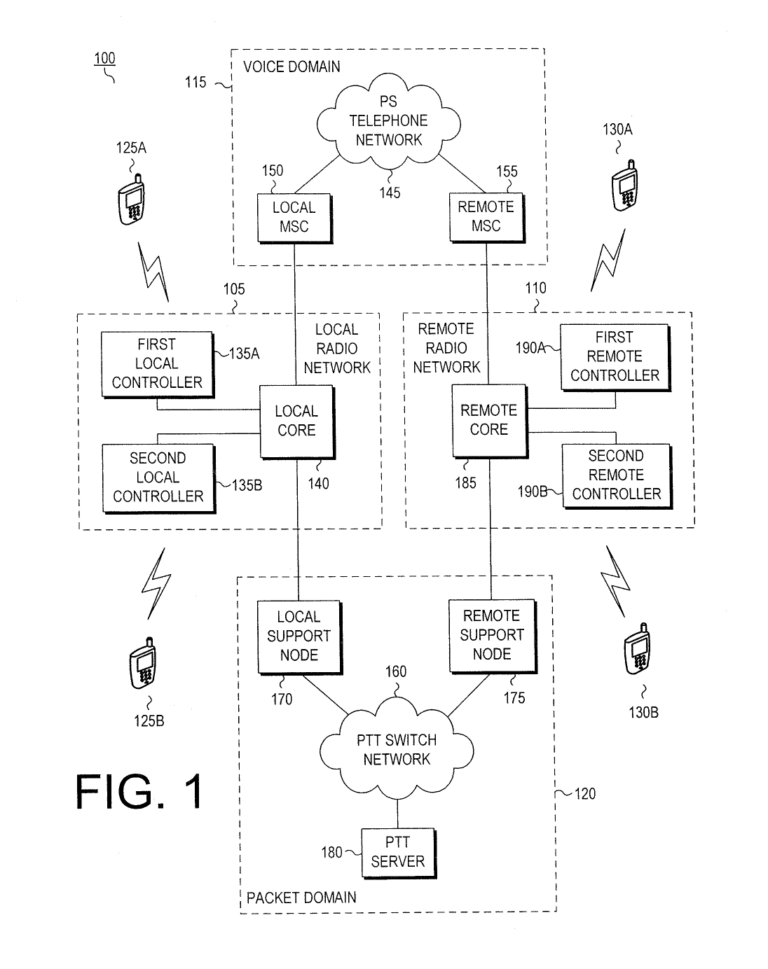

FIG. 1 is a block diagram of a communication network 100 according to disclosed embodiments. In some embodiments, the network 100 can be a universal terrestrial radio access network (UTRAN). However, alternate embodiments can apply this disclosure to any kind of radio network that requires a dedicated traffic channel to be set up before individual devices can talk to each other. A UTRAN embodiment is disclosed simply by way of example.

As shown in FIG. 1, the communication network 100 includes a local radio network 105 that is connected to a remote radio network 110 via a voice domain 115 and a packet domain 120. Multiple local handsets 125A, 125B communicate wirelessly with the local radio network 105, while multiple remote handsets 130A, 130B communicate wirelessly with the remote radio network 110. For ease of disclosure, the local handsets will sometimes be referred to simply by the reference number 125, while the remote handsets will sometimes be referred to simply by the reference number 130.

The local radio network 105 includes first and second local controllers 135A, 135B (referred to generically as local controllers 135), and a local core 140. The remote radio network 110 includes a remote core 185 and first and second remote controllers 190A, 190B (referred to generically as remote controllers 190). In embodiments in which the network 100 is a UTRAN, each of the local core 140 and the remote core 185 can be a radio network controller (RNC). The local controllers 135 and the remote controllers 190 can be nodes, e.g., base stations, connected to the RNCs.

The handsets 125, 130 can be any mobile or fixed-location devices that communicate over a radio network. In some embodiments they can be mobile telephones equipped to communicate via PTT as well as full duplex voice communication. Alternate embodiments can use fixed-location telephones, radio transceivers, or any other suitable communication device as a handset 125, 130. In fact, it is not necessary that an originating (i.e., local) handset 125 be identical to a receiving (i.e., remote) handset 130. All that is required is that the two handsets 125, 130 are part of the same network 100 and are configured to communicate with each other.

The handsets 125, 130 communicate voice and PTT packet data with an associated controller 135, 190, which then coordinates with the relevant core 140, 185. As necessary, the core 140, 185 sends and receives data across the voice domain 115 or the packet domain 120, depending upon the type of data that is to be sent/received.

The voice domain 115 operates to transmit conventional telephone voice data. It includes a public switch (PS) telephone network 145, a local mobile switch center (MSC) 150, and a remote MSC 155. The local MSC 150 sends voice data to the local core 140 that it receives from the PS telephone network 145, and receives voice data from the local core 140 that it forwards to the PS telephone network 145 for routing. Likewise, the remote MSC 155 sends voice data to the remote core 185 that it receives from the PS telephone network 145, and receives voice data from the remote core 185 that it forwards to the PS telephone network 145 for routing.

The packet domain 120 operates to transmit PTT voice data packets. It includes a PTT switch network 160, a local support node 170, a remote support node 175, and a PTT server 180. In some embodiments, the local support node 170 and the remote support node 175 can be nodes that support general packet radio service (GPRS), such as a serving GPRS support node/gateway GPRS support node (SGSN/GGSN).

Although the local radio network 105 is shown as having two local controllers 135, and the remote radio network 110 is shown as having two remote controllers 190, this is by way of example only. Each radio network 105, 110, can have one or more controllers 135, 190. Likewise, although each controller 135, 190 is shown as connecting to a single handset 125, 130, this is by way of example only. Each controller 135, 190 may connect to multiple handsets 125, 130 throughout a local or remote network. In addition, although only a local radio network 110 and a remote radio network 125 are shown, this is by way of example only. The voice domain 115 and the packet domain 120 can connect to multiple separate networks, each having its own core and controllers, and connected to its own group of handsets.

Furthermore, the terms remote and local are relative terms used by way of example, and should not be considered to indicate anything other than the fact that the local radio network 105 is separate from the remote radio network 110.

In addition, although the above disclosed embodiments involve a local handset 125 in a local radio network 110 connecting to a remote handset 130 in a remote radio network 125, this is by way of example only. In other embodiments it is possible for a PTT connection to be made with devices in the same radio network. For example, with respect to FIG. 1, it would be possible for a first local handset 125A to open a PTT connection with a second local handset 125B.

Push-to-Talk Call Setup Signal Timing

In order for a local handset 125 to enter into PTT communication with a remote handset 130, it is necessary to set up the call. This call setup includes passing a call request from the local handset 125 to the remote handset 130 via the local radio network 105, the packet domain 120, and the remote radio network 110; sending a call acknowledgement from the remote handset 130 to the local handset 125 via the remote radio network 110, the packet domain 120, and the local radio network 105; and setting up traffic channels for both the local handset 125 and the remote handset 130.

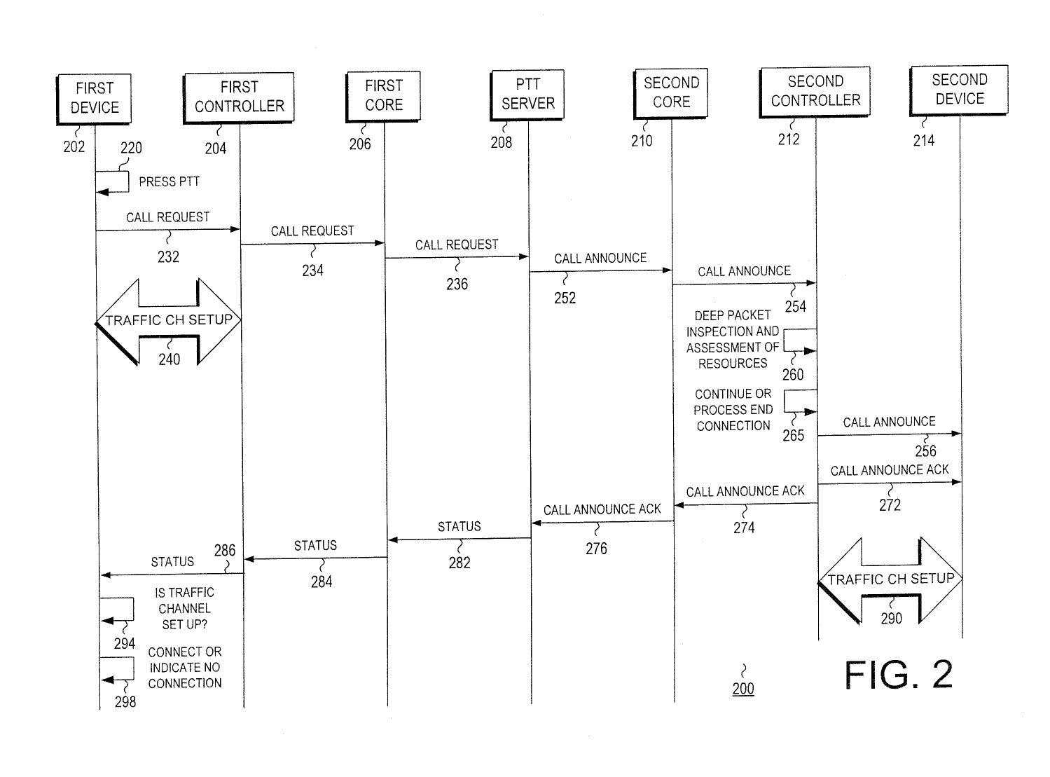

FIG. 2 is a system flow diagram showing call setup according to a disclosed embodiment. As shown in FIG. 2, the operation begins when the user of the first device 202 (i.e., the local handset 125) presses the PTT button 220. At this point all routing information (e.g., the telephone number) of a target second device 214 (e.g., a remote handset 130A) will have been entered in to the first device 202.

The first device 202 then sends a call request (operation 232) to a first controller 204 (e.g., a first local controller 135A). This call request includes all of the information necessary for completing a PTT connection. This may include identifying information for the first device, identifying information for the second device, and any other information required for a connection. The call request is made over a control channel, so there should be no question of there being available bandwidth for sending the request.

After sending the call request (operation 232), the first device 202 also begins negotiation with the first controller 204 to set up a traffic channel. This traffic channel will represent a sufficient bandwidth outside of the control channel for passing PTT voice packets. The control channel is dedicated to passing administrative information, not for passing voice packets. Therefore, a dedicated traffic channel is necessary for actual PTT communications.

By sending the call request before the traffic channel is set up for the first device 202 by the first controller 204, it is possible to speed up the overall connection process. In this operation it will not be necessary to monitor whether the traffic channel is properly set up for the first device 202 by the first controller 204 before the call request is forwarded to the first core 206. Instead, it is assumed that the channel will be set up properly, and the connection will succeed. A final check will be made at a later time to make certain this channel set up actually occurred. However, the time savings in performing operations in parallel more than makes up for the chance that a traffic channel will not properly be set up, making the attempt to create a PTT connection fail.

As the first controller 204 is working with the first device to set up the traffic channel 240, the first controller 204 forwards the call request to the first core 206 (e.g., the local core 140) (operation 234), which then forwards the call request to the PTT server 208 (e.g., the PTT server 180) (operation 236). Again, this operation is done over a control channel, and is performed in parallel with the traffic channel setup 240.

The PTT server 208 processes the call request (operation 236), determines how to route the request based on information regarding the target second device 214 contained in the call request, and sends a call announcement to the second core 210 (e.g., remote core 185) (operation 252) over the control channel.

The second core 210 then forwards the call announcement to a second controller 212 (e.g., first remote controller 190A) associated with the second device 214 over the control channel (operation 254). At this point, the second controller 210 performs a packet inspection of the call announcement and makes an assessment of available resources 260. This operation determines whether the original PTT call request is valid, and whether there are enough resources at the second radio network (e.g., the remote radio network 125) to properly make the PTT connection. Based on this packet inspection and assessment of resources 260, the second controller 212 will determine whether to continue the process or end the connection 265.

If the second controller 212 ends the connection, then it does nothing more, allowing the call request (operation 232) from the first device 202 to eventually time out. In this embodiment no specific negative acknowledgement is sent back to the first device 202 indicating an ended connection. If, however, the second controller 202 determines that the call request should continue, then it forwards the call announcement to the second device 214 (e.g., handset 190A) over the control channel (operation 256).

Upon receiving the call announcement (operation 256), the second device 214 immediately sends a call announcement acknowledgement back to the second controller 212 over the control channel (operation 272). This call announcement acknowledgement indicates that the call request has been received and acted upon.

After sending the call announcement acknowledgement back to the second controller 212 (operation 272), the second device 214 also begins negotiation with the second controller 212 to set up a dedicated traffic channel 290. This traffic channel will represent a sufficient bandwidth outside of the control channel for passing PTT voice packets. The control channel is dedicated to passing administrative information, not for passing voice packets. Therefore, a dedicated traffic channel is necessary for actual PTT communications. However, since the second controller 212 has already made an assessment of resources 260, there should be sufficient resources to properly set up the traffic channel 290.

By sending the call announcement acknowledgement before the traffic channel is set up for the second device 214 by the first controller 212, it is possible to speed up the overall connection process. In this operation it will not be necessary to monitor whether the traffic channel is properly set up for the second device 214 by the second controller 212 before the call announcement acknowledgement is sent. Instead, it is assumed that the channel will be set up properly, and the connection will succeed, since the second controller has already confirmed that sufficient system resources are available.

As the first controller 204 is working with the first device to set up the traffic channel 240, the first controller 204 forwards the call request to the first core 206 (e.g., the local core 140) (operation 234), which then forwards the call request to the PTT server 208 (e.g., the PTT server 180) (operation 236). Again, these signals are sent over the control channel, and this operation is performed in parallel with the traffic channel setup 290.

The PTT server 208 processes the call announcement acknowledgement (operation 276), and sends a status message first core 206 (operation 282), which then forwards the status message to the associated first controller 204 (operation 284), which in turn forwards the status message to the proper first device 202 (operation 286).

At this point, the first device 202 makes a final determination as to whether the traffic channel setup 240 at the first device 202 was successful 294. Based on this determination, the first device then either makes the connection or indicates that no connection was made.

Operations of Call Setup

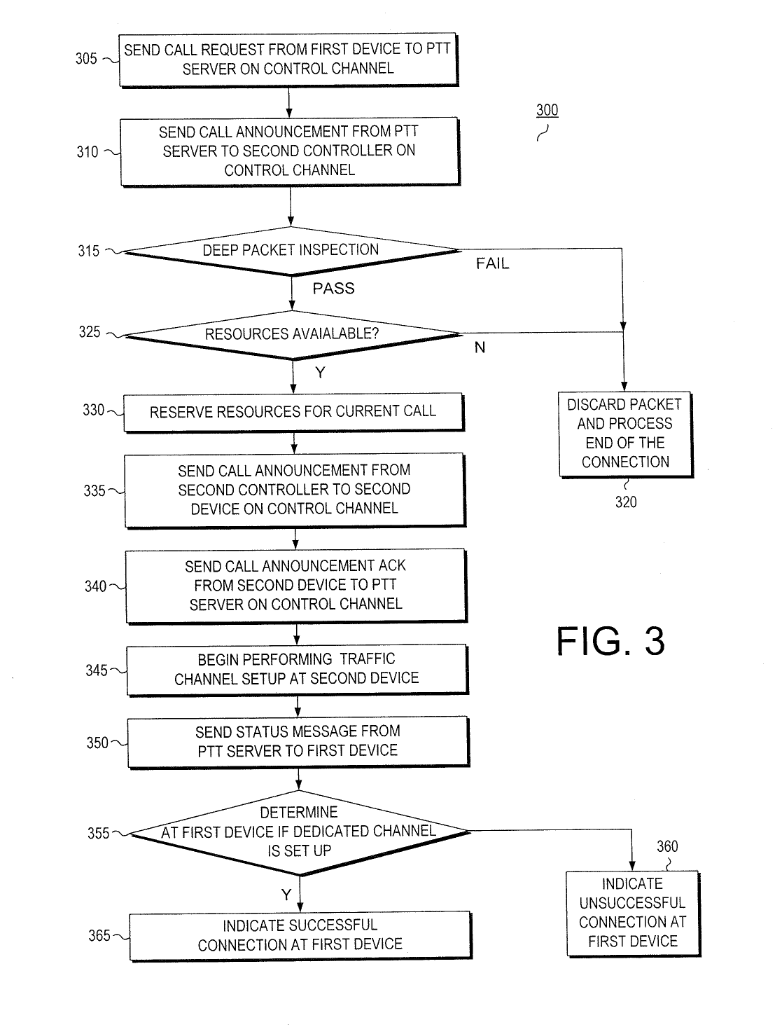

A general description of call setup operations will now be described. FIG. 3 is a flow chart showing call setup (300) between two devices according to disclosed embodiments.

As shown in FIG. 3, operations begin when a first device sends a call request to the PTT server over a control channel (305). This call request is sent to the PTT server via an associated controller and core (e.g., the first controller and the first core), as necessary, and indicates a desire to create a PTT connection with a second device.

The PTT server then sends a call announcement to a second controller over a control channel (310). This call announcement can be send to the second controller via an associated core, as necessary. The second controller is the controller that governs the operations of the second device (i.e., the target device).

Upon receiving the call announcement, the second controller performs a packet inspection of the call announcement to determine if it is acceptable (315). If the call announcement fails the packet inspection, then the second controller discards the packet and processes the end of the connection (320).

If, however, the call announcement passes the packet inspection, the second controller proceeds to determine whether there are sufficient resources (e.g., traffic channel bandwidth) available locally for processing the initial call request to the second device (325). If the second controller determines that there are not sufficient resources available to process the call (e.g., there are not sufficient resources to assign a traffic channel to the second device), then the second controller discards the packet and processes the end of the connection (320), regardless of the fact that the call announcement has passed packet inspection (315).

If, however, the second controller determines that there are sufficient resources available for the requested connection, then it reserves those resources for the current call (330), and then sends a call announcement to the second device over the control channel (335).

Upon receiving the call announcement from the second controller, the second device then proceeds to send a call announcement acknowledgment to the PTT server across the control channel (340). This call announcement acknowledgement is sent to the PTT server via an associated controller and core (e.g., the second controller and the second core), as necessary, and indicates acknowledgment of the request to create a PTT connection with the first device.

After sending the call announcement acknowledgement, the second device also begins performing traffic channel setup with the second controller. Normally there would be a chance that there would not be sufficient traffic channel resources for such an operation. However, since at this point the second controller has already determined that sufficient resources are available and has reserved them (325, 330), the second device should be able to set up the traffic channel with no problems.

Upon receiving the call announcement acknowledgement from the second device, the PTT proceeds to send a status message to the first device (350). This status message is sent to the first device via an associated controller and core (e.g., the first controller and the first core), as necessary, and indicates that the call request has been acknowledged and approved.

At this point, since the processing of the call request proceeded without completing traffic channel setup at the first device, the first device now determines whether a dedicated traffic channel has been properly set up for the first device (355). If it has not, then the first device indicates an unsuccessful connection (360).

If, however, the first device determines that the dedicated traffic channel has been properly set up, it indicates a successful connection and proceeds with PTT operations with the second device (365). At this point the request will have been made and acknowledged, and both devices will have set up dedicated traffic channels.

Furthermore, by sending the call request from the first device to the PTT server prior to completing setting up a dedicated traffic channel at the first device, and by sending the call announcement acknowledgment from the second device to the PTT server prior to completing setting up a dedicated traffic channel at the second device, the system avoids additional latency and can make the PTT connection more quickly.

Operations at the Originating Device

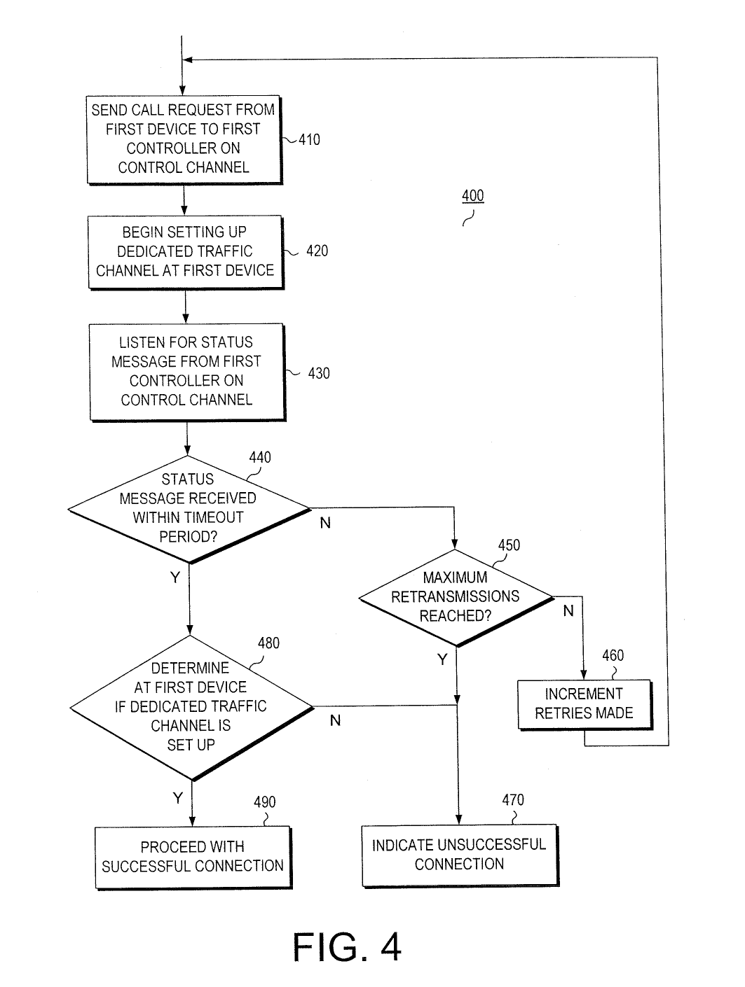

Operations will now be considered from the point of view of the originating (i.e., first) device. FIG. 4 is a flow chart showing the retransmission of a call request 400 according to disclosed embodiments.

As shown in FIG. 4, operations begin when the first device sends a call request to a first controller on a control channel (410). This call request is directed to a PTT server, and indicates a request to connect via a PTT connection to a second device.

The first device then begins to set up a dedicated traffic channel with the first controller (420). It performs this action after sending the call request (410). However, the first device will not wait for the setup of the dedicated traffic channel to be completed before it sends the call request.

After sending the call request (410), the first device begins to listen for a status message from the first controller over a control channel (430). This status message would be sent from a PTT server and would indicate that the call request has been accepted.

The first device waits for at most a timeout period to see if it receives a status message (440). If it does not receive a status message within the timeout period, then it considers the call request to be a failure, and determines whether it has reached the maximum number of allowed retransmissions (450). This can be determined by examining a tallied number of retries made, which number can be saved, for example, in a register. This number of retries will start at zero for an initial call request.

If the first device has not reached the maximum number of retransmissions, then it will increment the number of retries made (460), and once more send a call request to the first controller over the control channel (410), and repeat the steps of trying to make a connection (420, 430, 440).

If, however, the maximum number of retransmissions has been reached, then the first device indicates an unsuccessful connection (470). This can be done by emitting a certain tone, displaying a message on a screen, vibrating a phone in a particular manner, or any other suitable way of indicating a failure to connect.

If the first device does receive a status message from the first controller within the timeout period, then it proceeds to determine whether the dedicated traffic channel has been properly set up between the first device and the first controller (480). It will assume at this point that the second device (i.e., the target device) already has a dedicated traffic channel set up.

If the first device determines that the dedicated traffic channel has not been properly set up, then it will indicate an unsuccessful connection (470).

If, however, the first device determines that the dedicated traffic channel has been properly set up, then it will proceed with a successful connection and allow the first device to make a PTT connection with the second device (490).

Operations at the Target Device

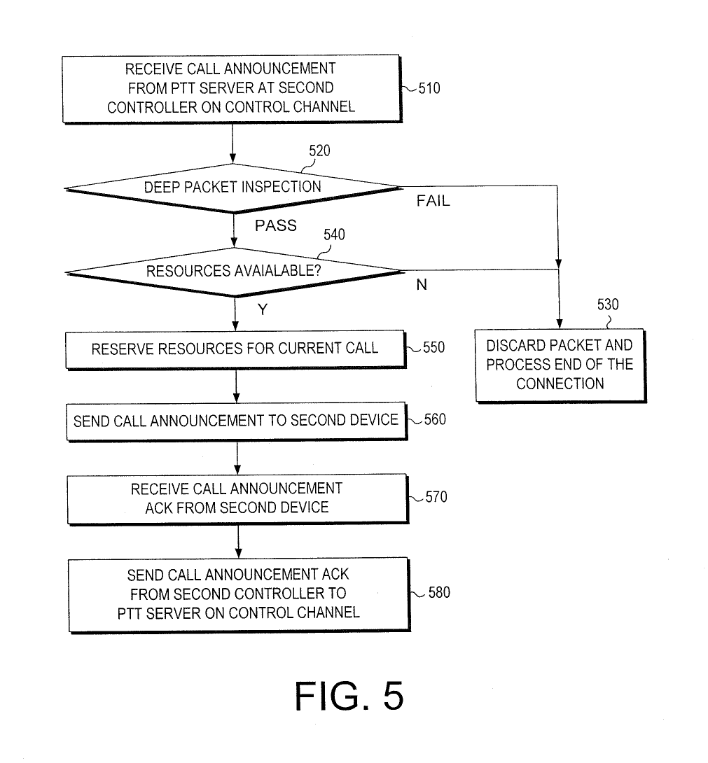

Operations will now be considered from the point of view of a destination (i.e., second) controller. FIG. 5 is a flow chart showing call setup at a destination controller according to disclosed embodiments.

As shown in FIG. 5, operation begins when a second controller receives a call announcement from a PTT server over a control channel (510). This call announcement indicates that a first device wishes to enter into a PTT communication with the second device.

Upon receiving the call announcement, the second controller performs a packet inspection of the call announcement to determine if it is acceptable (520). If the call announcement fails the packet inspection, then the second controller discards the packet and processes the end of the connection (530).

If, however, the call announcement passes the packet inspection, the second controller proceeds to determine whether there are sufficient resources (e.g., traffic channel bandwidth) available locally for processing the initial call request to the second device (540). If the second controller determines that there are not sufficient resources available to process the call (e.g., there are not sufficient resources to assign a traffic channel to the second device), then the second controller discards the packet and processes the end of the connection (530), regardless of the fact that the call announcement has passed packet inspection (520).

If the second controller determines that there are sufficient resources available for the requested connection, then it reserves those resources for the current call (550), and then sends a call announcement to the second device over the control channel (560).

After sending the call announcement to the second device, the second controller should quickly receive a call announcement acknowledgement from the second device (570). This will generally be received before the second device has completed setting up a dedicated traffic channel. However, since by this point the second controller has already determined that there are sufficient resources available (540), and has reserved those resources for the current call (550), there should not be any problem with the second device setting up a dedicated traffic channel.

Once it receives the call announcement acknowledgement from the second device, the second controller forwards the call announcement acknowledgement to the PTT server on the control channel. This will typically be done via a core that connects the second controller to the PTT server.

At this point, the second controller has completed its connection operations. It will consider the connection complete unless it receives no response from the first device (i.e., the calling device) within a certain timeout period. This could occur, for example, if the first device were somehow unable to set up its own dedicated traffic channel.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method of a first device setting up a communication connection, comprising:
sending a communications request to a system server over a control channel, requesting the communications connection between the first device and a second device;
receiving a status message from the system server indicating that a dedicated traffic channel is being set up by the second device;
determining whether the dedicated traffic channel has been properly set up for the first device;
sending data packets over the dedicated traffic channel to the second device if it is determined that the dedicated traffic channel has been properly set up; and
indicating an unsuccessful connection if it is determined that the dedicated traffic channel has not been properly set up.

2. The method of claim 1,
wherein the communications connection is a push-to-talk (PTT) call,
wherein the system server is a PTT server,
wherein the communication request is a PTT request, and
wherein the data packets are PTT packets.

3. The method of claim 1,
wherein the communications connection is a game-playing connection,
wherein the system server is a gaming server,
wherein the communication request is a game request, and
wherein the data packets are gaming packets.

4. The method of claim 1,
wherein the communications connection is a voice over IP (VoIP) call,
wherein the system server is a VoIP server,
wherein the communication request is a VoIP request, and
wherein the data packets are VoIP packets.

5. The method of claim 1,
wherein the communications request is sent to the system server via a local radio network, and
wherein the status message is received from the system server via the local radio network.

6. The method of claim 5, wherein the local radio network is a universal terrestrial radio access network (UTRAN).

7. The method of claim 1,
wherein the operation of indicating an unsuccessful connection includes one of sounding a tone on the first device, displaying a message on the first device, or playing a sound file on the first device.

8. The method of claim 1,
wherein the operation of determining whether the dedicated traffic channel has been properly set up includes:
determining whether the first device is in a dedicated channel state.

9. A method of a first device setting up a communications connection, comprising:
sending a communications request to a system server over a control channel, requesting the communications connection between the first device and the second device;
listening for timeout period for a status message from the system server over the control channel, the status message indicating that a dedicated traffic channel is being set up by the second device;
repeating the operations of sending the communications request and listening for timeout period for the status message a set number of times if the status message is not received from the system server within the timeout period;
determining whether the dedicated traffic channel has been properly set up if the status message is received from the system server within the timeout period;
sending data packets over the dedicated traffic channel to the second device if it is determined that the dedicated traffic channel has been properly set up; and
indicating an unsuccessful connection if it is determined that the dedicated traffic channel has not been properly set up or if no status message is heard after repeating the operations of sending the communications request and listening for timeout period for the status message the set number of times.

10. The method of claim 9,
wherein the communications connection is a push-to-talk (PTT) call,
wherein the system server is a PTT server,
wherein the communication request is a PTT request, and
wherein the data packets are PTT packets.

11. The method of claim 9,
wherein the communications connection is a game-playing connection,
wherein the system server is a gaming server,
wherein the communication request is a game request, and
wherein the data packets are gaming packets.

12. The method of claim 9,
wherein the communications request is sent to the system server via a local radio network; and
wherein the status message is received from the system server via the local radio network.

13. The method of claim 1, wherein the local radio network is a universal terrestrial radio access network (UTRAN).

14. The method of claim 9,
wherein the operation of indicating an unsuccessful connection includes one of sounding a tone on the source device, displaying a message on the source device, or playing a sound file on the source device.

15. The method of claim 9,
wherein the operation of determining whether the dedicated traffic channel has been properly set up includes:
determining whether the first device is in a dedicated channel state.

16. A method of a radio network controller setting up a communications connection, comprising:
receiving a communications request from a system server over a control channel, requesting the communications connection be set up between with a remote device;
receiving a status message from the system server indicating that a dedicated traffic channel is being set up;
determining whether the dedicated traffic channel has been properly set up;
sending data packets over the dedicated traffic channel if it is determined that the dedicated traffic channel has been properly set up;
repeating the operations of sending a communications request, receiving a status and
indicating an unsuccessful connection if it is determined that the dedicated traffic channel has not been properly set up.

17. The method of claim 16,
wherein the communications connection is a push-to-talk (PTT) call,
wherein the system server is a PTT server,
wherein the communication request is a PTT request, and
wherein the data packets are PTT packets.

18. The method of claim 16,
wherein the communications connection is a game-playing connection,
wherein the system server is a gaming server,
wherein the communication request is a game request, and
wherein the data packets are gaming packets.

19. A method of a controller setting up a communications connection, comprising:
receiving a connection announcement from a system server over a control channel, the connection announcement requesting a communications connection between a first device and a second device;
determining whether required resources are available at the second device to handle the communications;
discarding the connection announcement if it is determined that the required resources are not available at the second device to handle the communications;
reserving the required resources at the second device if it is determined that the required resources are available at the second device to handle the communications;
sending the connection announcement to the second device if it is determined that the required resources are available at the second device to handle the communications;
receiving a connection announcement acknowledgement from the second device if the connection announcement was sent to the second device; and
sending the connection announcement acknowledgement to the system server if the connection announcement acknowledgement was received from the second device.

20. The method of claim 19,
wherein the communications connection is a push-to-talk (PTT) call,
wherein the connection announcement is a push-to-talk (PTT) call announcement, and
wherein the system server is a PTT server.

21. The method of claim 19,
wherein the communications connection is a game-playing connection,
wherein the connection announcement is a game connection announcement, and
wherein the system server is a gaming server.

22. The method of claim 19,
wherein the second controller is a part of a local radio network that is connected between the second device and the system server.

23. The method of claim 22, wherein the local radio network is a universal terrestrial radio access network (UTRAN).

24. The method of claim 19, further comprising:
performing a packet inspection on the connection announcement prior to determining whether sufficient resources are available at the second device to handle the communications.

25. The method of claim 19, further comprising:
sending a negative acknowledgement packet to the first device via the system server, indicating negative acknowledgement of the call request, after discarding the connection announcement if it is determined that sufficient resources are not available at the second device to handle the communications.
